(19) United States
(12) Patent Application Publication
(10) Pub. No.: US 2025/0110210 A1
(43) Pub. Date: Apr. 3, 2025

(54) METHOD, DEVICE, TERMINAL DEVICE, AND STORAGE MEDIUM FOR DETERMINING OBJECT REFLECTANCE

(71) Applicant: SUTENG INNOVATION TECHNOLOGY CO., LTD., Shenzhen (CN)

(72) Inventor: Xi FENG, Shenzhen (CN)

(73) Assignee: SUTENG INNOVATION TECHNOLOGY CO., LTD., Shenzhen (CN)

(21) Appl. No.: 18/784,938

(22) Filed: Jul. 26, 2024

(30) Foreign Application Priority Data
Sep. 28, 2023 (CN) 202311290027.4

(51) Int. Cl. G01S 7/41

(52) U.S. Cl. CPC G01S 7/411

(57) ABSTRACT

The present application pertains to the field of radar systems technology and provides a method, device, terminal device, and storage medium for determining the reflectance of a target object. The method involves obtaining the emission parameters of a detection signal emitted by a radar and the echo data of the echo signal and determining a correction coefficient based on the emission parameters or the echo data. The correction coefficient is related to the transmittance of the material through which the detection signal passes and is used to correct the reflectance of the object. The reflectance of the object is calculated based on the correction coefficient and the echo data.

### CROSS-REFERENCE TO RELATED APPLICATION

The present application claims the benefit of priority to Chinese Patent Application No. 202311290027.4, filed on Sep. 28, 2023, which is hereby incorporated by reference in its entirety.

### TECHNICAL FIELD

The present application pertains to the field of radar systems technology, and particularly to a method, device, terminal device, and storage medium for determining object reflectance.

### TECHNICAL BACKGROUND

Due to their high resolution, high sensitivity, strong anti-interference ability, and unaffected performance under dark conditions, radar systems are commonly used in fields such as autonomous driving, logistics vehicles, robotics, and intelligent public transportation. Radar can not only detect the distance of objects but also determine the reflectance of objects to achieve target recognition. The reflectance of an object can be calculated using reflectance calibration results and the detected echo data. However, the transmittance of the radar's optical window may be inconsistent, which affects the accuracy of the calculated reflectance of the object.

### SUMMARY

Embodiments of this application provide a method, device, terminal device, and storage medium for determining object reflectance, which can improve the accuracy of calculating object reflectance in scenarios with inconsistent transmittance.

In a first aspect, embodiments of this application provide a method for determining object reflectance, including:
obtaining emission parameters of a detection signal emitted by a radar and echo data of an echo signal, wherein the echo signal is the signal received by the radar after the detection signal is reflected by the object;
determining a correction coefficient based on the emission parameters and/or the echo data, wherein the correction coefficient is related to the transmittance of the material through which the detection signal passes and is used to correct the reflectance of the object; and
calculating the reflectance of the object based on the correction coefficient and the echo data.

In an embodiment, the emission parameters of the detection signal include an emission angle of the detection signal. Determining the correction coefficient based on the emission parameters includes:
indexing based on the emission angle of the detection signal, to obtain the correction coefficient corresponding to the emission angle.

In an embodiment, determining the correction coefficient based on the echo data includes:
determining a distance of the object based on the echo data; and
indexing based on the object's distance to obtain the correction coefficient corresponding to the distance.

In an embodiment, calculating the reflectance of the object based on the correction coefficient and the echo data includes:
calculating an echo energy characteristic value based on the echo data;
correcting the echo energy characteristic value based on the correction coefficient, to obtain a corrected echo energy characteristic value; and
calculating the reflectance of the object based on the corrected echo energy characteristic value.

In an embodiment, calculating the reflectance of the object based on the correction coefficient and the echo data includes:
calculating the reflectance of the object based on the echo data; and
correcting the reflectance of the object based on the correction coefficient, to obtain a corrected reflectance.

In an embodiment, the emission angle includes an emission vertical angle and/or an emission horizontal angle.

In an embodiment, the emission parameters include transmittance distribution data. Determining the correction coefficient based on the emission parameters and/or the echo data includes:
determining the transmittance corresponding to the detection signal based on the transmittance distribution data; and
calculating the correction coefficient based on the transmittance corresponding to the detection signal.

In an embodiment, calculating the reflectance of the object based on the correction coefficient and the echo data includes:
correcting the reflectance calibration result based on the correction coefficient, to obtain the corrected reflectance calibration result; and
calculating the reflectance of the object based on the echo data and the corrected reflectance calibration result.

In an embodiment, calculating the reflectance of the object based on the correction coefficient and the echo data includes:
calculating an echo energy characteristic value based on the echo data; and
calculating the reflectance of the object based on the echo energy characteristic value, the correction coefficient, and the reflectance calibration result.

In an embodiment, the method for determining object reflectance further includes obtaining the transmittance distribution data.

In an embodiment, obtaining the transmittance distribution data includes:
obtaining a transmittance curve of the material through which the detection signal passes; and
determining the transmittance corresponding to the emission angle from the transmittance curve to obtain the transmittance distribution data.

In the second aspect, embodiments of this application provide a device for determining object reflectance, including:
an obtaining unit configured to obtain emission parameters of a detection signal emitted by a radar and echo data of an echo signal, wherein the echo signal is the signal received by the radar after the detection signal is reflected by the object;
a determining unit configured to determine a correction coefficient based on the emission parameters and/or the echo data, wherein the correction coefficient is related to the transmittance of the material through which the detection signal passes and is used to correct the reflectance of the object; and
a calculating unit configured to calculate the reflectance of the object based on the correction coefficient and/or the echo data.

In the third aspect, embodiments of this application provide a terminal device, including a processor, a memory, and a computer program stored in the memory and executable on the processor, wherein the processor implements the method embodiments when executing the computer program.

In the fourth aspect, embodiments of this application provide a computer-readable storage medium, wherein the computer-readable storage medium stores a computer program, and when the computer program is executed by a processor, the method embodiments are executed.

In the fifth aspect, embodiments of this application provide a computer program product. When the computer program product is run on a terminal device, it enables the terminal device to execute the method embodiments.

By determining a correction coefficient related to the transmittance of the material through which the detection signal passes based on the emission parameters and/or the echo data, and by using this correction coefficient and the echo data to determine the reflectance of the object, effectively reduce the impact of inconsistent transmittance on the accuracy of the reflectance calculation, thereby improving the accuracy of the reflectance calculation of the object.

### BRIEF DESCRIPTION OF DRAWINGS

To clearly illustrate the technical solutions in the embodiments of this application, the accompanying drawings required for describing the embodiments will be briefly introduced below. It is evident that the accompanying drawings in the following description are merely some embodiments.

FIG. 1 is a schematic diagram of a LiDAR structure, according to some embodiments of the present disclosure;

FIG. 2 is a flowchart of the implementation of the method for determining object reflectance, according to some embodiments of the present disclosure;

FIG. 3 is a flowchart of step S13 in the method for determining object reflectance, according to some embodiments of the present disclosure

FIG. 4 is a schematic diagram of the process of correcting the reflectance calibration result in the method for determining object reflectance, according to some embodiments of the present disclosure;

FIG. 5 is another flowchart of step S13 in the method for determining object reflectance, according to some embodiments of the present disclosure;

FIG. 6 is a schematic diagram of the process of correcting the reflectance in the method for determining object reflectance, according to some embodiments of the present disclosure;

FIG. 7 is a schematic diagram of the structure of a device for determining object reflectance, according to some embodiments of the present disclosure;

FIG. 8 is a schematic diagram of the structure of a terminal device, according to some embodiments of the present disclosure; and

FIG. 9 is a schematic diagram of the structure of a terminal device, according to some embodiments of the present disclosure.

### DETAILED DESCRIPTION

In the following description, details such as particular system structures and techniques are presented for the purpose of explanation and not limitation, in order to provide a thorough understanding of the embodiments of this application. Detailed descriptions of well-known systems, devices, circuits, and methods are omitted to avoid unnecessary details that might obscure the description of this application.

The term “and/or” as used in the description and the appended claims indicate any combination of one or more of the associated listed items and all possible combinations, and include these combinations. Furthermore, in the description of this application and the appended claims, the terms “first,” “second,” “third,” etc. are used merely to distinguish descriptions and should not be construed as indicating or implying relative importance.

References to “one embodiment” or “some embodiments” in the description mean that specific features, structures, or characteristics described in conjunction with the embodiment are included in one or more embodiments of the application. Thus, statements in different parts of this specification that refer to “one embodiment,” “some embodiments,” “in other embodiments,” or “in yet another embodiment” are not necessarily all referring to the same embodiment, unless specifically stated otherwise. The terms “comprising,” “including,” “having,” and their derivatives all mean “including but not limited to,” unless specifically stated otherwise.

A LiDAR (Light Detection and Ranging) is a radar system that uses laser beams to detect information such as the position and speed of targets. It can detect the distance of objects and detect the reflectance of objects used for target recognition. The working principle of LiDAR is to emit a detection signal to the target. After reaching the target, the detection signal is reflected by the target object, forming an echo signal. By receiving the signal reflected back from the target (the echo signal), the LiDAR can determine relevant information about the target based on the echo signal, such as the target's distance, position, height, speed, attitude, shape, and reflectance, thereby realizing target detection, target tracking, and target recognition. The reflectance of an object refers to the percentage of the radiation energy reflected by the object relative to the total radiation energy of the incident signal. Different objects have different reflectance, which are mainly determined by the surface characteristics of the object, the wavelength of the incident signal, and the incident angle.

According to the distance measurement method, LiDAR can be divided into time-of-flight (ToF) measurement, frequency-modulated continuous wave (FMCW) measurement, and triangulation measurement. Among them, ToF measurement and FMCW measurement can detect targets at farther distances under outdoor sunlight and can be used for vehicle-mounted LiDAR. According to the scanning method, LiDAR can be divided into mechanical LiDAR with overall rotation, semi-solid-state LiDAR with stationary transmit-receive modules, and solid-state LiDAR.

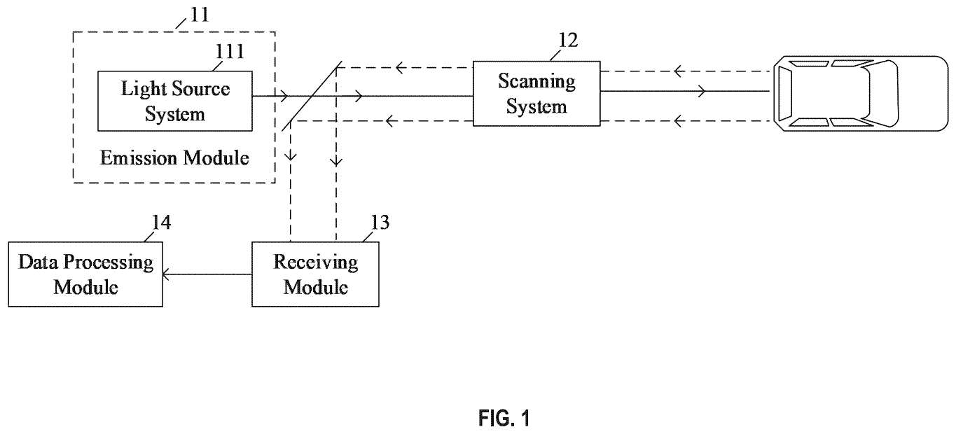

FIG. 1 is a schematic diagram of a LiDAR structure, according to some embodiments.

In an embodiment, as shown in FIG. 1, LiDAR 10 generally includes an emission module 11, a scanning system 12, a receiving module 13, and a data processing module 14. The emission module 11 may include a light source system 111.

The light source system 111 is used to generate the laser beam required for LiDAR 10 detection. The light source system 111 may include optical devices such as lasers and emission lens groups. The scanning system 12 is used to scan the laser beam generated by the light source system 111 point by point, so that the laser beam can hit different positions at different times. The scanning system 12 can be a mechanical scanning system, a semi-solid-state scanning system, or a solid-state scanning system. The receiving module 13 is used to receive echo signals reflected by different positions of the object at different times and can perform photoelectric conversion and other operations. The data processing module 14 can process the echo signals received and processed by the receiving module 13, perform calculations, complete three-dimensional image reconstruction, and obtain information such as the target's distance, spatial angle, speed, and reflectance.

When calculating the reflectance of an object, LiDAR usually bases the calculation on the echo energy characteristic value. The echo energy characteristic value includes, the echo area obtained by sampling with an analog-to-digital converter (ADC), the echo pulse width obtained by sampling with a time-to-digital converter (TDC), and the echo amplitude obtained by calculating the slope after sampling multiple TDC thresholds. After determining the echo energy characteristic value from the echo signal, the reflectance of the object can be calculated by decoupling the entire signal transmission and data processing chain, establishing a system model, and basing calculations on this model.

In an embodiment, the reflectance of objects can be determined through reflectance calibration results. The above determination of the reflectance of the object by means of the reflectance calibration results may be: this involves measuring the echo energy characteristic values of standard reflectance objects with different reflectance at different distances and establishing a mapping relationship between reflectance and echo energy characteristic values, thereby obtaining the calibration results of reflectance corresponding to different standard reflectance objects.

In an embodiment, LiDAR can receive echo signals, calculate the object's distance and echo energy characteristic values from the echo signals, and directly look up the corresponding reflectance based on the calibration results.

For scanning LiDAR, the scanning optical path of each emission module will change within a certain field of view (FOV) range. The size of the FOV determines the detection range of the radar, and the LiDAR can detect objects within the FOV range. The size of the FOV can be determined by the optical instruments of LiDAR. However, calibrating the reflectance for each emission angle would consume a lot of time and resources. Therefore, reflectance calibration is usually conducted for fixed emission angles to obtain the calibration results of reflectance. When calculating the reflectance, the same calibration result is used for different emission angles.

Using the same calibration result for reflectance calculation at different emission angles requires that the intensity of the echo signal does not change with the angle. Therefore, this method imposes certain requirements on the optical system of LiDAR, such as ensuring that the transmittance of the laser beams emitted at different emission angles through the window lens remains as consistent as possible.

For LiDAR, the requirement of maintaining consistent transmittance of laser beams emitted at different emission angles can be better achieved by designing the surface shape of the window lens. However, for vehicle-mounted radar, when LiDAR is installed inside the vehicle, it is difficult to maintain consistent transmittance at different positions of the windshield, especially for windshields with large tilt angles. When the emission angle of the radar has a large angle with the normal vector of the windshield, the transmittance significantly decreases. In this case, using the existing reflectance calibration results to determine the reflectance of the object will lead to significant differences in the measured reflectance of objects with the same reflectance at different emission angles within the FOV range of the radar. The inconsistent transmittance of the vehicle windshield affects the accuracy of the calculated reflectance of the object.

Embodiments of this application provide a method for determining the reflectance of an object. The method determines a correction coefficient related to the transmittance of the material through which the detection signal passes based on the emission parameters and/or the echo data to correct the reflectance of the object. This correction coefficient is then used along with the echo data to determine the reflectance of the object, effectively reducing the impact of inconsistent transmittance on the accuracy of the reflectance calculation, thereby improving the accuracy of the reflectance calculation.

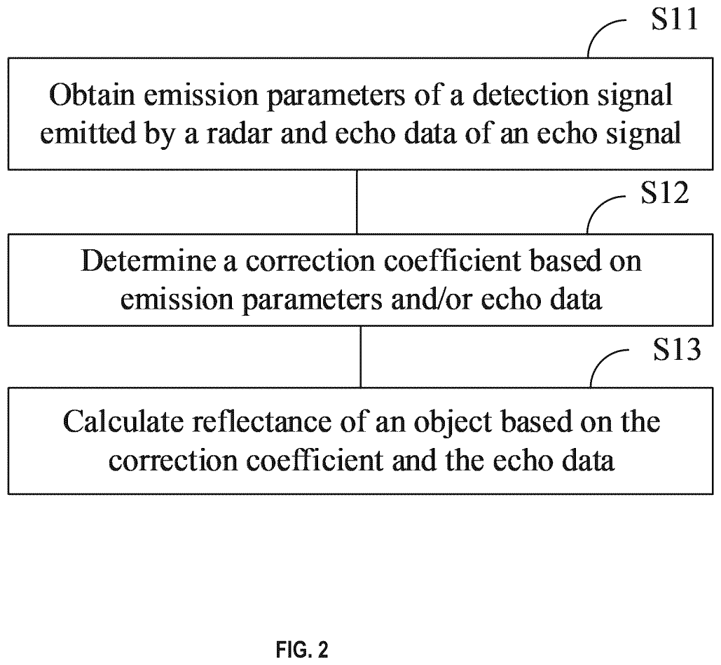

FIG. 2 is a flowchart of the implementation of the method for determining object reflectance, according to some embodiments.

In an embodiment, as shown in FIG. 2, the method for determining the reflectance of an object may specifically include steps S11 to S13.

The entity executing the method for determining the reflectance of an object provided by the embodiments of this application can be the LiDAR 10 mentioned above, such as the data processing module 14 of LiDAR 10. The entity executing the method for determining the reflectance of an object can be a terminal device in communication with LiDAR 10, such as a mobile phone, desktop computer, laptop, tablet, wearable device, cloud server, or radar auxiliary computer in various application scenarios. The following description takes LiDAR 10 as the executing entity as an example:

In step S11, obtain the emission parameters of the detection signal emitted by the radar and the echo data of the echo signal.

In an embodiment, the echo signal is the signal received by LiDAR after the detection signal is reflected by the object.

In an embodiment, the emission parameters of the detection signal emitted by the radar include, emission angle, emission energy, emission time, and transmittance distribution data of the material through which the detection signal passes.

In an embodiment, the material through which the detection signal passes refers to the object that the laser beam emitted by the radar needs to penetrate to reach the object. In different application scenarios, this material may correspond to different objects. For example, in an application scenario of reflectance correction of LiDAR itself, this material may be the window lens of LiDAR; and in an application scenario of vehicle-mounted radar with LiDAR installed inside the vehicle, this material may be the windshield or other car windows.

In an embodiment, the emission module of LiDAR emits the detection signal according to an emission control command. Therefore, each time the detection signal is emitted, LiDAR can record the emission parameters corresponding to the detection signal. LiDAR can determine the emission parameters of the emission module when emitting the detection signal based on the emission control command. After receiving the echo signal, the receiving module of LiDAR processes the echo signal through photoelectric conversion and other operations, and sends the processed echo signal to the data processing module. Therefore, LiDAR can process the echo signal through the data processing module to obtain the corresponding echo data.

In step S12, determine the correction coefficient based on the emission parameters and/or echo data.

In an embodiment, the correction coefficient is a coefficient related to the transmittance of the material through which the detection signal passes, used to correct the reflectance of the object.

In an embodiment, the correction coefficient can be determined by establishing a mapping relationship between the correction coefficient and the emission parameters in advance. After obtaining the emission parameters, LiDAR can determine the corresponding correction coefficient. Alternatively, a mapping relationship between the correction coefficient and the echo data can be established in advance. After obtaining the echo data, LiDAR can determine the corresponding correction coefficient. Another approach is to establish a mapping relationship between the correction coefficient, emission parameters, and echo data. After obtaining the emission parameters and echo data, LiDAR can determine the corresponding correction coefficient.

In an embodiment, the emission parameters may include the emission angle, which can include the emission vertical and/or horizontal angles. The echo data can determine the distance of the object.

In an embodiment, the correction coefficient is stored in an array in the data processing module. The array can be a three-dimensional array with dimensions corresponding to the emission horizontal angle, emission vertical angle, and the object's distance. Therefore, LiDAR can determine the correction coefficient based on these three-dimensional data, i.e., LiDAR determines the emission horizontal angle and emission vertical angle based on the emission parameters and determines the object's distance based on the echo data. The corresponding correction coefficient is determined based on the determined emission horizontal angle, emission vertical angle, and the object's distance.

In an embodiment, the array can be a two-dimensional array with dimensions corresponding to any two parameters among the emission horizontal angle, emission vertical angle, and the object's distance. For example, the two dimensions of the two-dimensional array can be the emission horizontal angle and emission vertical angle, or the emission horizontal angle and the object's distance, assuming the vertical direction's transmittance remains unchanged and does not need correction, or the emission vertical angle and the object's distance, assuming the horizontal direction's transmittance remains unchanged and does not need correction.

The array can be a one-dimensional array, using any one parameter among the emission horizontal angle, emission vertical angle, or the object's distance to map the correction coefficient.

The emission parameters can include other parameters, such as the emission energy value. The echo data can calculate other parameters, such as the echo energy characteristic value. The above examples use the emission angle and/or the object's distance to establish the correction coefficient mapping array for explanation.

In an embodiment, multiple measurements and experiments can establish the mapping relationship between the correction coefficient and various parameters, forming the correction coefficient mapping array. After determining the relevant emission parameters and/or echo data during the actual detection process, the required correction coefficient can be indexed.

In some embodiments, if the correction coefficient mapping is established based on the emission angle of the detection signal, i.e., the emission parameters of the detection signal include the emission angle, step S12 involves indexing the emission angle of the detection signal, to obtain the correction coefficient corresponding to the emission angle.

In some embodiments, if the correction coefficient mapping is established based on the object's distance, step S12 involves determining the object's distance based on the echo parameters and indexing the correction coefficient corresponding to the object's distance.

In an embodiment, the correction coefficient can be used to correct the echo energy characteristic value or the reflectance calculation result. That is, the correction coefficient can correct the echo energy characteristic value first, and then calculate the reflectance based on the corrected echo energy characteristic value. In an embodiment, the correction coefficient can be used directly to correct the reflectance after calculating the reflectance based on the echo energy characteristic value.

In some embodiments, the emission parameters can include transmittance distribution data. LiDAR can determine the transmittance corresponding to the detection signal based on the transmittance distribution data, and then calculate the correction coefficient based on the transmittance corresponding to the detection signal.

In an embodiment, the transmittance distribution data includes the transmittance data of the material through which the detection signal passes for each emission angle within the FOV range of LiDAR.

In step S13, calculate the reflectance of the object based on the correction coefficient and the echo data.

In some embodiments, as described in step S12, the correction coefficient can be used to correct the echo energy characteristic value. Therefore, after receiving the echo signal and obtaining the echo data, LiDAR can calculate the echo energy characteristic value based on the echo data. LiDAR corrects the echo energy characteristic value based on the correction coefficient and uses the corrected echo energy characteristic value to calculate the reflectance of the object.

In some embodiments, as described in step S12, the correction coefficient can be used to correct the reflectance. Therefore, after receiving the echo signal and obtaining the echo data, LiDAR can calculate the reflectance of the object based on the echo data and then use the correction coefficient to correct the reflectance of the object, obtaining the corrected reflectance.

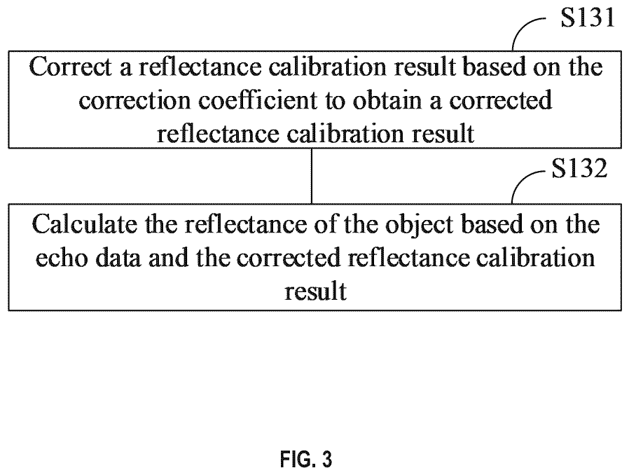

FIG. 3 is a flowchart of step S13 in the method for determining object reflectance, according to some embodiments

As shown in FIG. 3, FIG. 3 shows the implementation flow of step S13 in the method for determining the reflectance of an object provided by the embodiments of this application. As shown in FIG. 3, in some embodiments, if the correction coefficient is determined based on the transmittance distribution data, step S13 includes the following steps:

S131: Correct a reflectance calibration result based on the correction coefficient to obtain a corrected reflectance calibration result.

The reflectance calibration result can be the related data obtained by calibration according to the existing reflectance calibration method.

The following is a description of the reflectance calibration process.

The reflectance calibration process establishes a mapping between the reflectance and the object's distance and the echo energy characteristic value at specific emission angles, i.e.,

ρ=f_{T}_{₀}(D,A),

where ρ represents the reflectance, D is the object's distance obtained from the echo data, A is the echo energy characteristic value related to the echo energy E, which can be expressed as A=g(E). The echo energy characteristic value can include echo area, echo pulse width, and echo amplitude. T₀ is the transmittance during calibration, a normalized parameter. If no windshield is placed during calibration, T₀=1; otherwise, T₀ is the transmittance of the windshield at the calibration angle.

Therefore, the transmittance distribution data of the windshield can be obtained first, T=h(p),
where p is the emission vector of the radar laser.

In an embodiment, the transmittance distribution data can be determined through measurements, theoretical calculations, or a combination of both.

In some embodiments, the transmittance distribution data can be obtained by first determining the transmittance curve of the material through which the detection signal passes through measurements. Then, based on the emission angles within the field of view (FOV) range of the LiDAR, the transmittance corresponding to each emission angle can be determined from the transmittance curve, forming the transmittance distribution data of the LiDAR's FOV range.

In an embodiment, the transmittance curve can be obtained by placing the LIDAR behind the material through which the detection signal passes, controlling the LiDAR to emit the laser beam at different emission angles, and using a detector to measure the transmittance at different emission angles. The collected data can then be used to fit the transmittance curve.

In an embodiment, LiDAR is installed inside the vehicle and placed behind the windshield. When LiDAR operates, it scans within the FOV range, meaning the emission angle of the laser beam continuously changes. For the emission vector p1, the corresponding transmittance is T₁=h(p₁), and the object's distance measured is D₁, and the echo characteristic value is A₁. Since the transmittance T₁ for the current emission angle is not equal to T₀, the reflectance cannot be calculated using the reflectance calibration result. Instead, the reflectance needs to be corrected using the correction coefficient.

In an embodiment, an echo energy obtained from a diffuse reflecting object can be expressed by the radar equation as:

$$E = {E}_{tx} {η}_{tx} {t}_{air}^{2} {ρη}_{rx} \frac{{T}^{2}}{4 {D}^{2}} cos {θ}_{i} ,$$

where Eₜₓ is the emission energy of the detection signal, Tₜₓ is the emission efficiency, tₐᵢᵣ² is the air attenuation coefficient, p is the reflectance of the object, ηᵣₓ is the receiving efficiency, and θᵢ is the incident angle of the laser on the object.

In an embodiment, considering the object's distance and transmittance, the expression of echo energy can be simplified as:

$$E ∝ ρ \frac{{T}^{2}}{{D}^{2}} ;$$

Further, it can be obtained:

$$E ( {T}_{1} , D , ρ ) = E ( {T}_{0} , D \cdot \frac{{T}_{0}}{{T}_{1}} , ρ ) ;$$

That is, the echo energy of the same reflectance object measured at distance D with transmittance T₁ is the same as the echo energy measured at distance

$$D \cdot \frac{{T}_{0}}{{T}_{1}}$$

with transmittance T₀. Since the echo energy characteristic value A is a related function of the echo energy E, the echo energy characteristic value is the same in both states, in an embodiment,

$$A ( {T}_{1} , D , ρ ) = A ( {T}_{0} , D \cdot \frac{{T}_{0}}{{T}_{1}} , ρ ) ;$$

Conversely, the reflectance of an object measured at distance D and echo energy characteristic value A with transmittance T₁ is the same as the reflectance of an object measured at distance

$$D \cdot \frac{{T}_{0}}{{T}_{1}}$$

and echo energy characteristic value A with transmittance T₀, i.e.,

$$ρ ( A , {T}_{1} , D ) = ρ ( A , {T}_{0} , D \cdot \frac{{T}_{0}}{{T}_{1}} ) ;$$

Further, it can be obtained:

$$ρ = {f}_{{T}_{1}} ( D , A ) = {f}_{{T}_{0}} ( D \cdot \frac{{T}_{0}}{{T}_{1}} , A ) ;$$

Thus, the reflectance can be corrected using the ratio of transmittances. When the emission vector is p₁, the object's distance measured is D₁, and the echo characteristic value is A₁. Based on the transmittance distribution data of the windshield, the correction coefficient

$$k = \frac{{T}_{0}}{{T}_{1}}$$

is obtained. If the windshield is installed during calibration, then

$$k = \frac{h ( {p}_{0} )}{h ( {p}_{1} )} ;$$

if no windshield is installed during calibration, then

$$k = \frac{1}{h ( {p}_{1} )} .$$

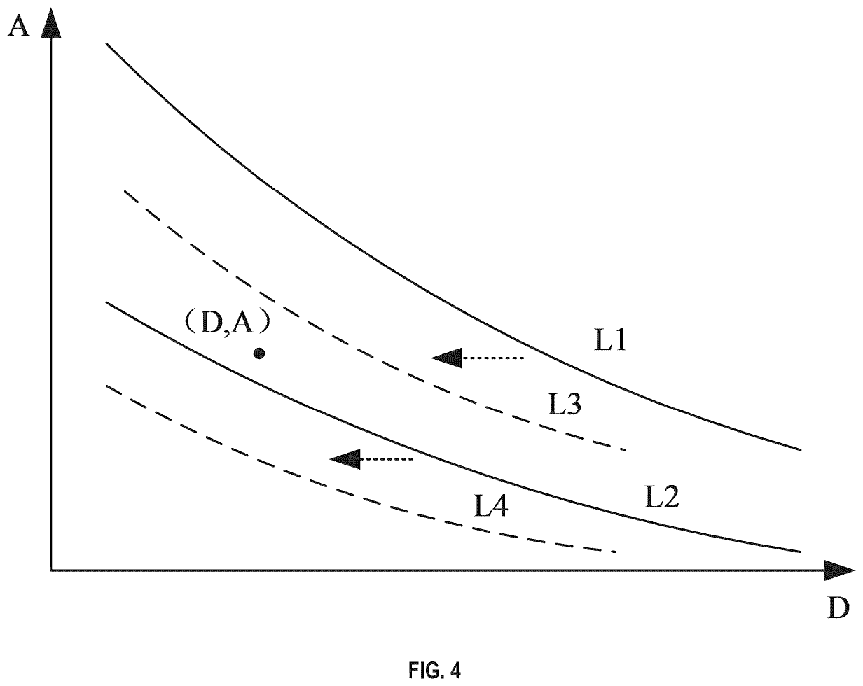

FIG. 4 is a schematic diagram of the process of correcting the reflectance calibration result in the method for determining object reflectance, according to some embodiments.

The correction coefficient can be used to correct the reflectance calibration result. As shown in FIG. 4, the horizontal axis represents the object's distance D, and the vertical axis represents the echo energy characteristic value A. In FIG. 4, L1 is the reflectance calibration result for reflectance ρ1, L2 is the reflectance calibration result for reflectance ρ2, L3 is the corrected reflectance calibration result for reflectance ρ1, and L4 is the corrected reflectance calibration result for reflectance ρ2.

S132: Calculate the reflectance of the object based on the echo data and the corrected reflectance calibration result.

In an embodiment, after obtaining the corrected reflectance calibration result, the reflectance of the object can be calculated using the echo data and the corrected reflectance calibration result, thereby improving the accuracy of the reflectance calculation.

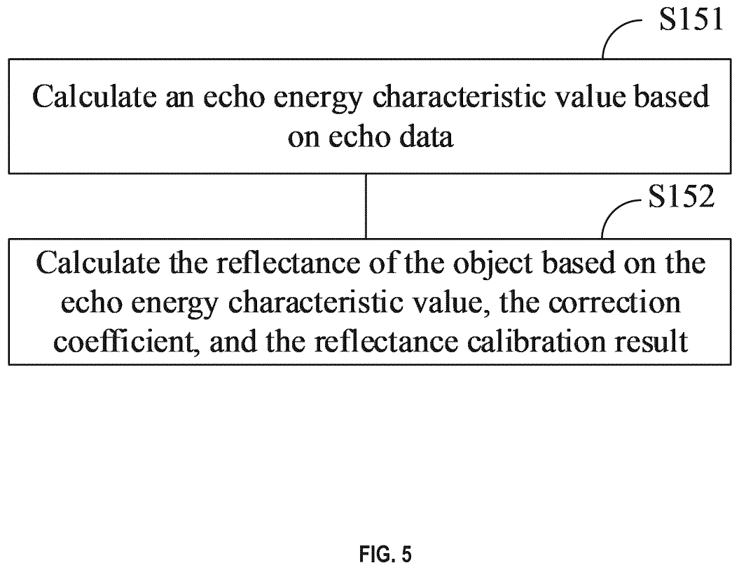

FIG. 5 is another flowchart of step S13 in the method for determining object reflectance, according to some embodiments.

As shown in FIG. 5, FIG. 5 shows the implementation flow of step S13 in the method for determining the reflectance of an object provided by the embodiments of this application. As shown in FIG. 5, in some embodiments, if the correction coefficient is determined based on the transmittance distribution data, step S15 includes the following steps:

S151: Calculate an echo energy characteristic value based on the echo data.

S152: Calculate the reflectance of the object based on the echo energy characteristic value, the correction coefficient, and the reflectance calibration result.

In an embodiment, besides using the correction coefficient to correct the reflectance calibration result, the echo energy characteristic value A, the object's distance D, and the correction coefficient k can be directly substituted into the reflectance calibration result to calculate the reflectance, i.e., ρ=f_{T}_{₀}(kD,A).

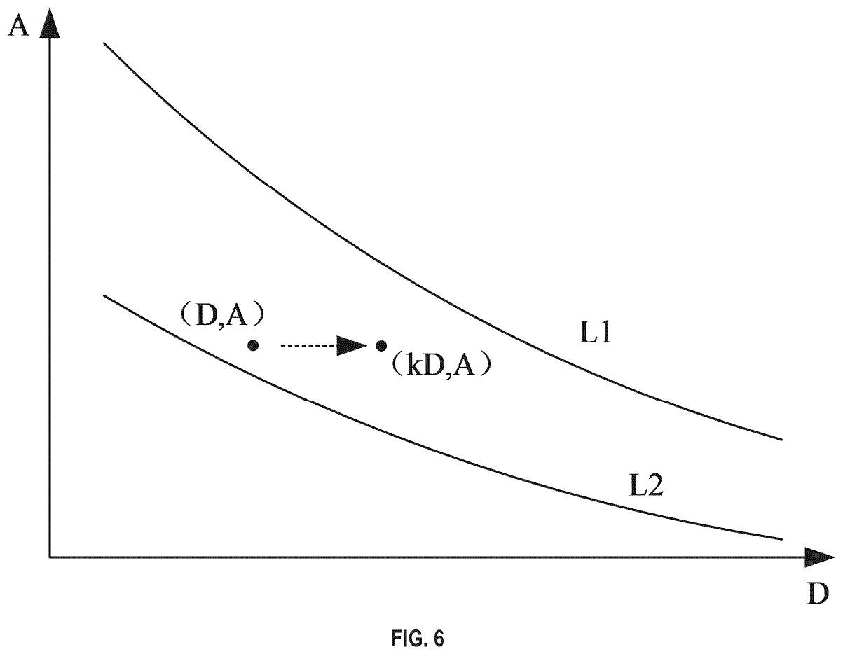

FIG. 6 is a schematic diagram of the process of correcting the reflectance in the method for determining object reflectance, according to some embodiments.

As shown in FIG. 6, the horizontal axis represents the object's distance D, and the vertical axis represents the echo energy characteristic value A. In FIG. 6, L1 is the reflectance calibration result for reflectance ρ1, and L2 is the reflectance calibration result for reflectance ρ2.

The method for determining the reflectance of an object provided by the embodiments of this application, determines a correction coefficient related to the transmittance of the material through which the detection signal passes based on the emission parameters and/or the echo data to correct the reflectance of the object. This correction coefficient is then used along with the echo data to determine the reflectance of the object, effectively reducing the impact of inconsistent transmittance on the accuracy of the reflectance calculation, thereby improving the accuracy of the reflectance calculation.

The sequence numbers of the steps in the above embodiments do not imply the order of execution. The execution sequence of each process should be determined by its functions and internal logic.

Based on the above method for determining the reflectance of an object, the embodiments of the present application further provide an implementation of the device for determining the reflectance of an object.

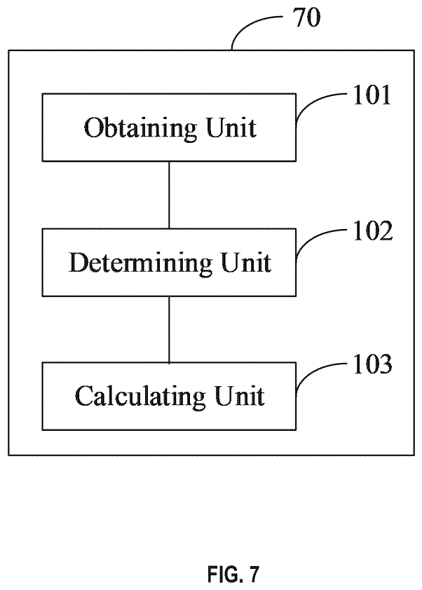

FIG. 7 is a schematic diagram of the structure of a device for determining object reflectance, according to some embodiments.

Referring to FIG. 7, in an embodiment, the device for determining the reflectance of an object includes units for executing the corresponding steps in the embodiment shown in FIG. 2. For details, please refer to the description of the corresponding embodiment in FIG. 2. For convenience, only the relevant parts are shown. As shown in FIG. 7, the device for determining the reflectance of an object 70 may include an obtaining unit 101, a determining unit 102, and a calculating unit 103, where: the obtaining unit 101 is configured to obtain emission parameters of a detection signal emitted by a radar and echo data of an echo signal; the echo signal is the signal received by the radar after the detection signal is reflected by the object;
the determining unit 102 is configured to determine a correction coefficient based on the emission parameters and/or the echo data; the correction coefficient is a coefficient related to the transmittance of the material through which the detection signal passes, used to correct the reflectance of the object; and
the calculating unit 103 is configured to calculate the reflectance of the object based on the correction coefficient and the echo data.

In an embodiment, the emission parameters of the detection signal include the emission angle, and the determining unit 102 is configured to index the emission angle of the detection signal to obtain the correction coefficient corresponding to the emission angle.

In an embodiment, the determining unit 102 is configured to determine the object's distance based on the echo data and index the correction coefficient corresponding to the object's distance.

In an embodiment, the calculating unit 103 may include a characteristic value calculating unit, a characteristic value correcting unit, and a reflectance calculating unit, where:

The characteristic value calculating unit is configured to calculate the echo energy characteristic value based on the echo data.

The correcting unit is configured to correct the echo energy characteristic value based on the correction coefficient, to obtain the corrected echo energy characteristic value.

The reflectance calculating unit is configured to calculate the reflectance of the object based on the corrected echo energy characteristic value.

In an embodiment, the calculating unit 103 may include a reflectance calculating unit and a reflectance correcting unit.

The reflectance calculating unit is configured to calculate the reflectance of the object based on the echo data.

The reflectance correcting unit is configured to correct the reflectance of the object based on the correction coefficient to obtain the corrected reflectance.

In an embodiment, the emission parameters include transmittance distribution data, and the determining unit 102 includes a transmittance determining unit and a correction coefficient determining unit.

The transmittance determining unit is configured to determine the transmittance corresponding to the detection signal based on the transmittance distribution data.

The correction coefficient determining unit is configured to calculate the correction coefficient based on the transmittance corresponding to the detection signal.

In an embodiment, the calculating unit 103 includes a calibration result correcting unit and a reflectance calculating unit.

The calibration result correcting unit is configured to correct the reflectance calibration result based on the correction coefficient, to obtain the corrected reflectance calibration result.

The reflectance calculating unit is configured to calculate the reflectance of the object based on the echo data and the corrected reflectance calibration result.

In an embodiment, the calculating unit 103 is configured to calculate the echo energy characteristic value based on the echo data; calculate the reflectance of the object based on the echo energy characteristic value, the correction coefficient, and the reflectance calibration result.

In an embodiment, the obtaining unit 101 is configured to obtain the transmittance distribution data.

In an embodiment, the obtaining unit 101 is configured to obtain the transmittance curve of the material through which the detection signal passes; and determine the transmittance corresponding to the emission angle from the transmittance curve to obtain the transmittance distribution data.

The information interaction, execution process, and other content between the units mentioned above are based on the same concept as the corresponding method embodiments. The specific functions and resulting technical effects can be referred to in the corresponding method embodiments, and will not be repeated here.

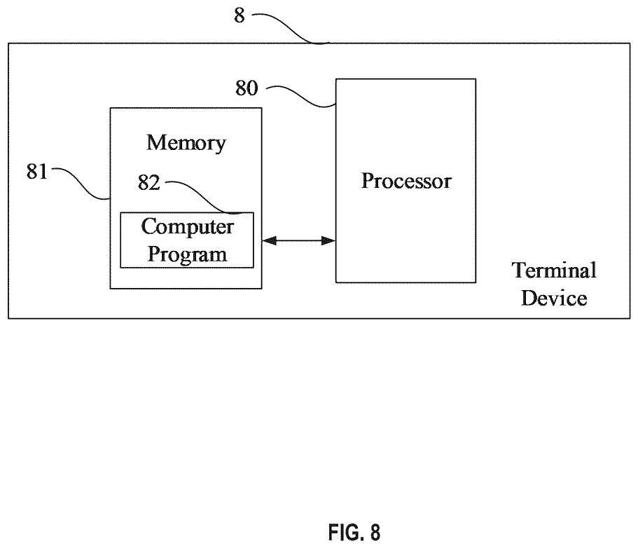

FIG. 8 is a schematic diagram of the structure of a terminal device, according to some embodiments.

FIG. 8 is a schematic diagram of the structure of a terminal device provided by another embodiment of this application. As shown in FIG. 8, the terminal device 8 provided in this embodiment includes a processor 80, a memory 81, and a computer program 82 stored in the memory 81 and executable on the processor 80, such as an image segmentation program. When the processor 80 executes the computer program 82, it realizes the steps of the method for determining the reflectance of an object in the embodiments of this application, such as steps S11 to S13 shown in FIG. 2. In an embodiment, when the processor 80 executes the computer program 82, it realizes the functions of each module/unit in the terminal device embodiments, such as the functions of units 101 to 103 shown in FIG. 7.

In an embodiment, the computer program 82 can be divided into one or more modules/units. The one or more modules/units are stored in the memory 81 and executed by the processor 80. The one or more modules/units can be a series of computer program instruction segments that can complete specific functions. These instruction segments describe the execution process of the computer program 82 in the terminal device 8. For example, the computer program 82 can be divided into an obtaining unit, a determining unit, and a calculating unit. For the specific functions of each unit, please refer to the corresponding descriptions of the units in FIG. 7.

The terminal device may include the processor 80 and the memory 81. FIG. 8 is only an example of the terminal device 8. It may include more or fewer components than those shown, or a combination of certain components, or different components. For example, the terminal device may also include input and output devices, network access devices, buses, etc.

The processor 80 can be a central processing unit (CPU), a general-purpose processor, a digital signal processor (DSP), an application-specific integrated circuit (ASIC), a field-programmable gate array (FPGA), or other programmable logic devices, discrete gates or transistor logic devices, discrete hardware components, etc. The general-purpose processor may be a microprocessor or any conventional processor.

The memory 81 can be an internal storage unit of the terminal device 8, such as a hard disk or memory of the terminal device 8. The memory 81 can be an external storage device of the terminal device 8, such as a plug-in hard disk, smart media card (SMC), secure digital (SD) card, flash card, etc. Further, the memory 81 can include both an internal storage unit and an external storage device of the terminal device 8. The memory 81 is used to store the computer program and other programs and data required by the terminal device. The memory 81 can also be used to temporarily store data that has been output or will be output.

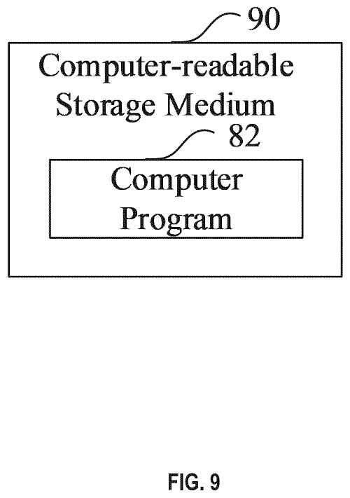

FIG. 9 is a schematic diagram of the structure of a terminal device, according to some embodiments

The embodiments of this application also provide a non-transitory computer-readable storage medium. As shown in FIG. 9, the non-transitory computer-readable storage medium 90 stores a computer program 82. When the computer program 82 is executed by the processor, it can realize the method for determining the reflectance of an object.

The embodiments of this application provide a computer program product. When the computer program product runs on a terminal device, it enables the terminal device to execute the method for determining the reflectance of an object.

The internal structure of the terminal device can be divided into different functional units or modules to complete all or part of the described functions. The functional units and modules in the embodiments can be integrated into one processing unit or can exist as separate physical units. The names of the functional units and modules are used to distinguish them from each other. The specific working process of the units and modules can refer to the corresponding process in the method embodiments, which will not be repeated here.

The units and algorithm steps described in the embodiments of this application can be implemented in electronic hardware, computer software, or a combination of both. Whether the functions are executed in hardware or software depends on the specific application and design constraints. Professionals can use different methods to realize the described functions for each specific application, but such implementations should not be regarded as beyond the scope of this application.

What is claimed is:

1. A method for determining reflectance of an object, comprising:
obtaining emission parameters of a detection signal emitted by a radar and echo data of an echo signal, wherein the echo signal is a signal received by the radar after the detection signal is reflected by the object;
determining a correction coefficient based on the emission parameters or the echo data, wherein the correction coefficient is a coefficient for correcting the reflectance of the object and is related to a transmittance of a material through which the detection signal passes; and
calculating the reflectance of the object based on the correction coefficient and the echo data.

2. The method according to claim 1, wherein the emission parameters of the detection signal comprise an emission angle of the detection signal, and the determining the correction coefficient based on the emission parameters comprises:
indexing based on the emission angle of the detection signal to obtain a correction coefficient corresponding to the emission angle.

3. The method according to claim 1, wherein the determining the correction coefficient based on the echo data comprises:
determining a distance of the object based on the echo data; and
indexing based on the distance of the object to obtain a correction coefficient corresponding to the distance.

4. The method according to claim 1, wherein the calculating the reflectance of the object based on the correction coefficient and the echo data comprises:
calculating an echo energy characteristic value based on the echo data;
correcting the echo energy characteristic value based on the correction coefficient to obtain a corrected echo energy characteristic value; and
calculating the reflectance of the object based on the corrected echo energy characteristic value.

5. The method according to claim 1, wherein the calculating the reflectance of the object based on the correction coefficient and the echo data comprises:
calculating the reflectance of the object based on the echo data; and
correcting the reflectance of the object based on the correction coefficient to obtain a corrected reflectance.

6. The method according to claim 2, wherein the emission angle comprises an emission vertical angle or an emission horizontal angle.

7. The method according to claim 1, wherein the emission parameters comprise transmittance distribution data, and the determining the correction coefficient based on the emission parameters or the echo data comprises:
determining transmittance corresponding to the detection signal based on the transmittance distribution data; and
calculating the correction coefficient based on the transmittance corresponding to the detection signal.

8. The method according to claim 7, wherein the calculating the reflectance of the object based on the correction coefficient and the echo data comprises:
correcting a reflectance calibration result based on the correction coefficient to obtain a corrected reflectance calibration result; and
calculating the reflectance of the object based on the echo data and the corrected reflectance calibration result.

9. The method according to claim 7, wherein the calculating the reflectance of the object based on the correction coefficient and the echo data comprises:
calculating an echo energy characteristic value based on the echo data; and
calculating the reflectance of the object based on the echo energy characteristic value, the correction coefficient, and a reflectance calibration result.

10. The method according to claim 7, further comprising:
obtaining the transmittance distribution data.

11. The method according to claim 10, wherein the obtaining the transmittance distribution data comprises:
obtaining a transmittance curve of a material through which the detection signal passes; and
determining transmittance corresponding to the emission angle based on the transmittance curve to obtain the transmittance distribution data.

12. A device for determining reflectance of an object, comprising:
an obtaining unit, configured to obtain emission parameters of a detection signal emitted by a radar and echo data of an echo signal, wherein the echo signal is a signal received by the radar after the detection signal is reflected by the object;
a determining unit, configured to determine a correction coefficient based on the emission parameters or the echo data, wherein the correction coefficient is a coefficient for correcting the reflectance of the object and is related to a transmittance of a material through which the detection signal passes; and
a calculating unit, configured to calculate the reflectance of the object based on the correction coefficient and the echo data.

13. A non-transitory computer-readable storage medium, wherein the non-transitory computer-readable storage medium stores a computer program, and when the computer program comprising readable instructions is executed by a processor, a method for determining reflectance of an object is implemented, where the method comprises:
obtaining emission parameters of a detection signal emitted by a radar and echo data of an echo signal, wherein the echo signal is a signal received by the radar after the detection signal is reflected by the object;
determining a correction coefficient based on the emission parameters or the echo data, wherein the correction coefficient is a coefficient for correcting the reflectance of the object and is related to a transmittance of a material through which the detection signal passes; and
calculating the reflectance of the object based on the correction coefficient and the echo data.
